(19) United States
(12) Patent Application Publication
(10) Pub. No.: US 2005/0135685 A1
(43) Pub. Date: Jun. 23, 2005

(54) [CIRCUIT AND METHOD OF DECOMPRESSING IMAGE]

(76) Inventors: Hung-Jen Huang, Hsinchu City (TW); Ying-Chih Yang, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,006

(22) Filed: Apr. 7, 2004

(30) Foreign Application Priority Data
Dec. 22, 2003 (TW) 92136370

(51) Int. Cl. G06K 9/36

(52) U.S. Cl. 382/233

(57) ABSTRACT

A circuit and a method of decompressing images are disclosed. The data amount of image is greatly increased after decompressing in an image decompressing circuit. Therefore, while a compressed image picture is received, a syntax or semantics pre-check is executed by the variable length decoding unit. The result of the pre-check is used to determine either to reload the compressed image or abort it. The result is also used to determine whether the decoded image data requires to be sent to an image picture recovery unit for performing further operations such as inverse quantization, inverse discrete cosine transform and motion compensation.

### CROSS REFERENCE TO RELATED APPLICATIONS

This application claims the priority benefit of Taiwan application serial no. 92136370, filed Dec. 22, 2003.

### BACKGROUND OF INVENTION

1. Field of the Invention

The present invention relates to a circuit and a method of image processing, and more particularly, to a circuit and a method of decompressing images.

2. Description of the Related Art

When storing the image data such as movies in various storage media, in order to save the storage space, an image compression standard such as Motion Picture Expert Group (MPEG) is commonly used to compress the original image data. Generally, the compression ratio of MPEG is about 8˜40 times. Therefore, when using a DVD player to play the images, the compressed image has to be decompressed by the image decompressing circuit first, such that the recovered image can be displayed in the display.

FIG. 1 is a schematic diagram illustrating an image decompressing operation of a conventional image decompressing circuit. In general, the image decompressing unit performs the image decompressing operation based on a sequence of Variable Length Decoding (VLD), Inverse Quantization (INVQ), Inverse Discrete Cosine Transformation (IDCT), and Motion Compensation (MC). In order to speed up the decompressing operation, the received image pictures are parallelly processed in a pipeline with a unit of block. As shown in the diagram, when VLD is processing the block #6, the INVQ is processing the block #5, the IDCT is processing the block #4, and the MC is processing the block #3, and the rest can be deduced by analogy.

Although the VLD performs the debug analysis on the block which is being processed before the normal decompression, since the subsequent decoding, inverse quantization, inverse discrete cosine transformation, and motion compensation are simultaneously processed in a pipeline. When the VLD finds out that an image picture is severely damaged, it may not have sufficient time to generate next new picture and the system is enforced to replay the previous picture once more for compensating and preventing the damaged picture from displaying. In addition, when the VLD just finds out that there is an error, it is possible that a portion of the damage image picture has been displayed for a while, thus cause an unrecoverable error.

### SUMMARY OF INVENTION

Therefore, it is an object of the present invention to provide a circuit and a method for decompressing images. A debug analysis is executed on a compressed image picture whose data amount is relatively small after the compressed image picture has been received. When the result of the debug analysis indicates that the compressed image picture is suitable for the subsequent decoding operation, a pipeline process is performed on the compressed image picture, such that the motion picture is displayed more smoothly and more accurately.

In accordance with the above objects and other advantages, a circuit for decompressing images is provided by the present invention. The circuit for decompressing images comprises a variable length decoding unit and an image picture recovery unit. Wherein, the variable length decoding unit receives a compressed image picture and executes a debug analysis on the compressed image picture. When the result of the debug analysis indicates that the compressed image picture is suitable for the subsequent decoding operation, a decoding operation is performed in pipeline on the compressed image picture. The image picture recovery unit electrically couples to the variable length decoding unit, and performs the subsequent operations such as inverse quantization, inverse discrete cosine transformation, and motion compensation with a pipeline process after the compressed image picture has been decoded with the pipeline process, so as to recover the received compressed image picture.

In an embodiment, if the valuable length decoding unit executes the debug analysis on the compressed image picture and cannot find any error data, this result of the debug analysis determines that the compressed image data is suitable for the subsequent decoding operation, so as to recover the received compressed image picture.

In an embodiment, if the valuable length decoding unit executes the debug analysis on the compressed image picture and finds an error data, then the compressed image picture is reloaded, and the debug analysis is executed on the compressed image picture again, so as to avoid wasting the system resource due to decoding the error data.

In an embodiment, if the valuable length decoding unit executes the debug analysis on the compressed image picture and finds more than one predetermined number of the error data and there is no sufficient time to reload the compressed image picture and when the picture is severely damaged, the displaying of the compressed image picture is aborted, and the subsequent decoding operation is not performed, so as to avoid displaying the severely damaged picture.

In an embodiment, if the valuable length decoding unit executes the debug analysis on the compressed image picture and finds less than a predetermined number of the error data and there is no sufficient time to reload the compressed image picture and when the picture is not severely damaged, this result of the debug analysis determines that the compressed image picture is suitable for the subsequent decoding operation, so as to perform the subsequent decoding operation.

In an embodiment, the variable length decoding unit of the image decompressing circuit can selectively turn on or turn off the debug analysis function for the compressed image picture.

The present invention further provides a method for decompressing images. The method comprises: receiving a compressed image picture, executing a debug analysis on the compressed image picture, and when the result of the debug analysis indicates that the compressed image picture is suitable for the subsequent decoding operation, executing the decoding operation on the compressed image picture with a pipeline process; and performing the subsequent operations such as inverse quantization, inverse discrete cosine transformation, and motion compensation with a pipeline process after the compressed image picture has been decoded with the pipeline process, so as to recover the received compressed image picture.

Wherein, when executing the debug analysis on the compressed image picture and not finding any error data, this result of the debug analysis determines that the compressed image data is suitable for the subsequent decoding operation, so as to recover the received compressed image picture.

Wherein, when executing the debug analysis on the compressed image picture and finding an error data, the compressed image picture is reloaded, and the debug analysis is executed on the compressed image picture again, so as to avoid wasting the system resource due to decoding the error data.

Wherein, when executing the debug analysis on the compressed image picture and finding more than a predetermined number of the error data and there is no sufficient time to reload the compressed image picture and when the picture is severely damaged, the displaying of the compressed image picture is aborted, and the subsequent decoding operation is not performed, so as to avoid displaying the severely damage picture.

Wherein, when executing the debug analysis on the compressed image picture and finding less than a predetermined number of the error data and there is no sufficient time to reload the compressed image picture and when the picture is not severely damaged, this result of the debug analysis determines that the compressed image picture is suitable for the subsequent decoding operation, so as to perform the subsequent decoding operation.

Wherein, the debug analysis function for the compressed image picture can be selectively turned on or turned off.

In summary, with the circuit and method for decompressing images provided by the present invention, since the debug analysis is performed on a compressed image picture in advance when the compressed image picture is just been received, and the decoding process is performed in pipeline on the compressed image picture only when the result of the debug analysis indicates that the compressed image picture is suitable for the subsequent decoding operation to avoid displaying the error picture, such that the motion picture is displayed more smoothly and more accurately.

### BRIEF DESCRIPTION OF DRAWINGS

The accompanying drawings are included to provide a further understanding of the invention, and are incorporated in and constitute a part of this specification. The following drawings illustrate embodiments of the invention, and together with the description, serve to explain the principles of the invention.

FIG. 1 is a schematic diagram illustrating an image decompressing operation of a conventional image decompressing circuit.

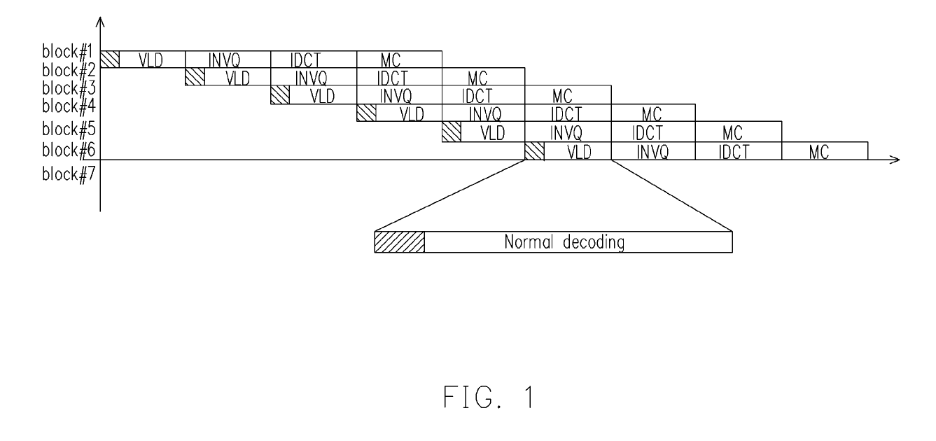

FIG. 2 is a circuit block diagram of an image decompressing circuit according to a preferred embodiment of the present invention.

FIG. 3 is a schematic diagram illustrating an image decompressing operation of an image decompressing circuit according to a preferred embodiment of the present invention.

### DETAILED DESCRIPTION

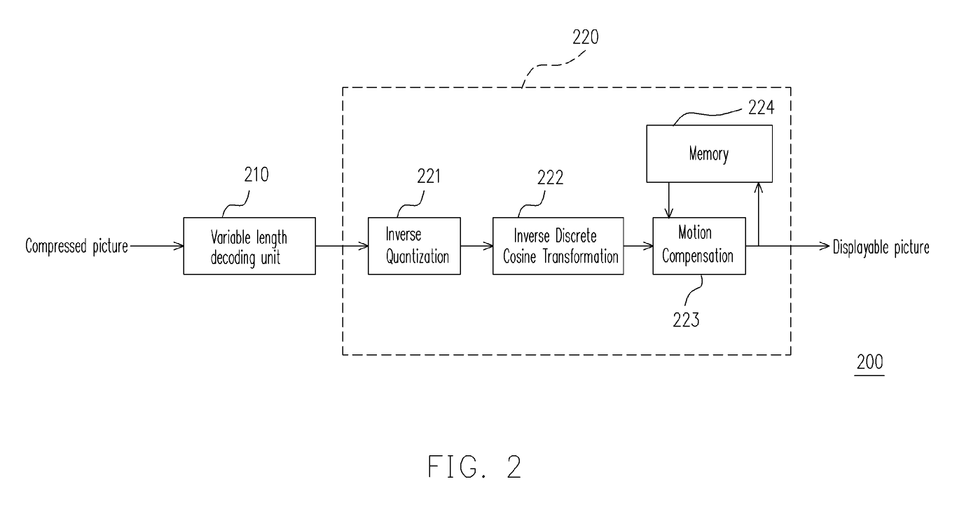

FIG. 2 is a circuit block diagram of an image decompressing circuit according to a preferred embodiment of the present invention. The image decompressing circuit 200 comprises a Variable Length Decoding Unit (VLD Unit) 210 and an image picture recovery unit 220, which is used to execute the functions such as Inversion Quantization (INVQ) 221, Inverse Discrete Cosine Transformation (IDCT) 222, and Motion Compensation (MC) 223 as shown in the diagram. Since it is common to store a difference between the current picture and the previous picture in the data processing method of the motion picture, the previous picture data has to be stored in the memory 224 during the motion compensation process for further picture recovery.

As mentioned above, it is common that the compression ratio of the image compression standard such as MPEG is about 8˜40 times, which causes a great difference in the data amount it processes. In order to avoid excessive resource is spent in decoding the picture which is damaged and not suitable for displaying and thus causing the non-smooth display of the image, or even being forced to display the severely damaged picture which can be perceived as error image picture by the user. In the present invention, the variable length decoding unit 210 in the diagram performs syntax and semantics pre-check after the compressed image picture has been received. In other words, the debug analysis is performed on the entire compressed image picture first, and when the result of the debug analysis indicates that there is no error data, it is determined that the compressed image picture is suitable for the subsequent decoding operation. Then, the decoding process is performed in pipeline on the compressed image picture, and the decoded data is sent to the image picture recovery unit 220 for performing the further INVQ, IDCT, and MC processes in pipeline.

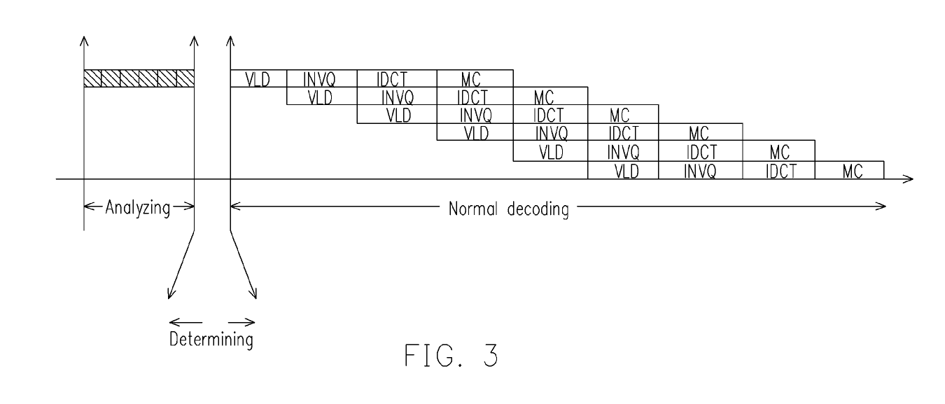

FIG. 3 is a schematic diagram illustrating an image decompressing operation of an image decompressing circuit according to a preferred embodiment of the present invention. As shown in the diagram, the variable length decoding unit 210 of the image decompressing circuit 200 according to a preferred embodiment of the present invention uses a two-phase execution mechanism. Wherein, in the first phase, the variable length decoding unit 210 reads a compressed image picture and performs a debug analysis on it, however the data is not sent to the backend image picture recovery unit 220 for further processing, thus there is no pipeline process, and the system can operate in full speed. Meanwhile, the speed for the variable length decoding unit 210 to analyze an image picture is about 8˜15 times faster than in the normal decoding operation, thus the object of accurately analyzing the images in high speed is achieved. Afterwards, an adequate subsequent mechanism is selected based on the analysis result.

When no error data is found, it is determined that the compressed image picture is suitable for the subsequent decoding operation as mentioned above, the operations such as decoding, INVQ, IDCT, and MC are performed in pipeline on the compressed image picture. When error data is found, the compressed image picture is reloaded, and the debug analysis is performed on the compressed image picture again, so as to avoid wasting the system resource due to decoding the error data.

In addition, when the valuable length decoding unit 210 executes the debug analysis on the compressed image picture and finds more than a predetermined number of the error data and there is no sufficient time to reload the compressed image picture and when the picture is severely damaged and not suitable for further decoding and displaying, the compressed image picture is aborted, and the subsequent decoding operation is not performed, so as to avoid displaying the severely damaged picture. Moreover, this picture is displayed in a stuff-picture displaying method.

In addition, when the valuable length decoding unit 210 executes the debug analysis on the compressed image picture and finds less than a predetermined number of the error data and there is no sufficient time to reload the compressed image picture and when the picture is not severely damaged, this result of the debug analysis determines that the compressed image picture is suitable for the subsequent decoding operation, so as to perform the subsequent decoding operation for normally displaying the picture.

Besides several cases mentioned above, when the variable length decoding unit 210 continuously analyzes a couple of image pictures and cannot find any error data, the debug analysis function for the compressed image picture can be selectively turned on or turned off.

In summary, a method for decompressing images can be deduced. The method comprises: receiving a compressed image picture, executing a debug analysis on the compressed image picture, and when the result of the debug analysis indicates that the compressed image picture is suitable for the subsequent decoding operation, executing the decoding operation on the compressed image picture with a pipeline process; and performing the subsequent operations such as inverse quantization, inverse discrete cosine transformation, and motion compensation with a pipeline process after the compressed image picture has been decoded with the pipeline process, so as to recover the received compressed image picture.

Wherein, when executing the debug analysis on the compressed image picture and not finding any error data, this result of the debug analysis determines that the compressed image data is suitable for the subsequent decoding operation, so as to recover the received compressed image picture.

Wherein, when executing the debug analysis on the compressed image picture and finding an error data, the compressed image picture is reloaded, and the debug analysis is executed on the compressed image picture again, so as to avoid wasting the system resource due to decoding the error data.

Wherein, when executing the debug analysis on the compressed image picture and finding more than a predetermined number of the error data and there is no sufficient time to reload the compressed image picture and when the picture is severely damaged, the displaying of the compressed image picture is aborted, and the subsequent decoding operation is not performed, so as to avoid displaying the severely damage picture.

Wherein, when executing the debug analysis on the compressed image picture and finding less than a predetermined number of the error data and there is no sufficient time to reload the compressed image picture and when the picture is not severely damaged, this result of the debug analysis determines that the compressed image picture is suitable for the subsequent decoding operation, so as to perform the subsequent decoding operation.

Wherein, the debug analysis function for the compressed image picture can be selectively turned on or turned off.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. An image decompressing circuit, comprising:
a variable length decoding unit, for receiving a compressed image picture and executing a debug analysis on the compressed image picture, wherein when a result of the debug analysis indicates that the compressed image picture is suitable for a subsequent decoding operation, executing a decoding process in pipeline on the compressed image picture; and
an image picture recovery unit, electrically coupled to the variable length decoding unit, for performing an inverse quantization, an inverse discrete cosine transformation and a motion compensation with a pipeline process after the compressed image picture has been decoded with the pipeline process, so as to recover the compressed image picture.

2. The image decompressing circuit of claim 1, wherein when the variable length decoding unit performs the debug analysis on the compressed image picture and finds no error data, the compressed image picture is determined suitable for the subsequent decoding operation.

3. The image decompressing circuit of claim 1, wherein when the variable length decoding unit performs the debug analysis on the compressed image picture and finds an error data, the compressed image picture is reloaded, so as to perform the debug analysis on the compressed image picture again.

4. The image decompressing circuit of claim 1, wherein when the variable length decoding unit performs the debug analysis on the compressed image picture and finds more than a predetermined number of the error data and there is no sufficient time to reload the compressed image picture, the compressed image picture is aborted.

5. The image decompressing circuit of claim 1, wherein when the variable length decoding unit performs the debug analysis on the compressed image picture and finds less than a predetermined number of the error data and there is no sufficient time to reload the compressed image picture, the compressed image picture is determined suitable for the subsequent decoding operation.

6. The image decompressing circuit of claim 1, wherein the variable length decoding unit can selectively turn on or turn off the debug analysis function for the compressed image picture.

7. A method of decompressing images, comprising:
receiving a compressed image picture;
executing a debug analysis on the compressed image picture, wherein when a result of the debug analysis indicates that the compressed image picture is suitable for a subsequent decoding operation, executing a decoding operation on the compressed image picture with a pipeline process; and
performing an inverse quantization, an inverse discrete cosine transformation and a motion compensation with a pipeline process after the compressed image picture has been decoded with the pipeline process, so as to recover the compressed image picture.

8. The method of decompressing images of claim 7, wherein when executing the debug analysis on the compressed image picture and not finding any error data, the compressed image data is determined suitable for the subsequent decoding operation.

9. The method of decompressing images of claim 7, wherein when executing the debug analysis on the compressed image picture and finding an error data, the compressed image picture is reloaded, and the debug analysis is executed on the compressed image picture again.

10. The method of decompressing images of claim 7, wherein when executing the debug analysis on the compressed image picture and finding more than a predetermined number of the error data and there is no sufficient time to reload the compressed image picture, the compressed image picture is aborted.

11. The method of decompressing images of claim 7, wherein when executing the debug analysis on the compressed image picture and finding less than a predetermined number of the error data and there is no sufficient time to reload the compressed image picture, the compressed image picture is determined suitable for the subsequent decoding operation.

12. The method of decompressing images of claim 7, wherein the debug analysis function for the compressed image picture can be selectively turned on or turned off.
